(19) United States
(12) Patent Application Publication
(10) Pub. No.: US 2006/0125147 A1
(43) Pub. Date: Jun. 15, 2006

(54) Segmented tire mold for off-road-vehicle tires

(76) Inventors: Todd Andrew Bachochin, Berlin Center, OH (US); Michael James Hogan, Tallmadge, OH (US); Larry Pete Ivery, Akron, OH (US); Michael Liam McBride, Akron, OH (US); William Frederick Niessen, Cuyahoga Falls, OH (US); Richard Mark Wieland, Akron, OH (US)

Correspondence Address: Howard M. Cohn, Suite 220, 21625 Chagrin Blvd., Cleveland, OH, 44122, US

(21) Appl. No.: 11/003,564

(22) Filed: Dec. 3, 2004

(51) Int. Cl. B29C 35/00; B29D 29/00

(52) U.S. Cl. 264/326; 425/35

(57) ABSTRACT

The present invention consists of both a method and apparatus for providing the upper and lower portions of two-part tire molds with an expansible opening to provide clearance for the insertion of green tires, in particular large green tires of the sort used on industrial or off-road vehicles. The tire mold according to the present invention provides a segmented tire mold wherein a plurality of circumferentially arranged segments that contribute to the shaping of the circumferential tread portion of a tire being molded are able to move in such a way as to include a radial component of motion that provides a larger diameter for each of the two mold portions during the green tire loading operation. Thus the internal circumferential region of the top portion and of the bottom portion is able to expand in diametrical dimension when the two part tire mold is open.

### TECHNICAL FIELD

This invention relates to methods and apparatus used in construction of large off-road-vehicle (ORV) tires. In particular the invention relates to the structure of heated tire molds of the sort used in the manufacture of ORV tires.

### BACKGROUND OF THE INVENTION

One set of characterizing features of tires for industrial or off-road vehicles (ORVs) is their large diameter, thickness and weight. Another characterizing feature is that tires for ORVs are produces in relatively small numbers compared to smaller tires for standard motor vehicles. Yet another characterizing feature is that tires for ORVs are more likely to be custom fabricated, with specialty tread patterns.

While it is true that the construction of all vehicle tires, large and small, is labor intensive, requiring large amounts of actual hands-on work, the fabrication of tires for industrial off-road vehicles (ORVs) entails manufacturing processes that is especially manpower intensive due to the relative small numbers of ORV tires that are produced each year and to the custom nature of such tires, especially in relation to tread patterns.

The manufacturing of pneumatic tires for motor vehicles of nearly all sizes entails the steps of creating the carcass and attaching thereto the tread and sidewalls, which are made of uncured rubber. The combination of carcass, tread and sidewalls, prior to curing of the rubber, is called a ‘green tire.’ The final step in the manufacture of a tire is the insertion of the green tire into a tire mold, wherein the tire is heated to a sufficiently high temperature to bring about the curing process. The tire is then removed from the mold and the manufacturing process is complete.

Whereas the manufacturing of tires for automobiles, even large automobiles such as sport utility vehicles, is a straightforward process involving relatively light-weight green tires, the manufacture of large tires for industrial or large off-road type vehicles of the sort used in earth moving and construction work entails the handling of large green tires weighting hundreds of pounds. The loading of such massive tires, in the green-tire stage of production, into the standard two-part tire molds having an upper portion and a lower portion can result in damage to the green tires during the loading process, because the diametrical and circumferential dimensions of the mold are so close to that each green tire being loaded into said mold as to result in interference.

This background information does not teach one skilled in the art how to design a tire mold that minimizes interference between the mold and a green tire being loaded into the mold.

### ASPECTS OF THE INVENTION

It is an aspect of the present invention to provide methods and apparatus as defined in one or more of the appended claims and, as such, having the capability of accomplishing one or more of the following subsidiary aspects.

One aspect of the present invention is to provide a method and apparatus for the loading of green tires into two-part tire molds so as to cause minimal dimensional interference between the inside portions of the mold's circumference and the perimeter portions of green tires being loaded into the mold.

Another aspect of the present invention is to provide a method and apparatus for the loading of large green tires of the sort used on industrial and large off road vehicles into large two-part tire molds so as to cause minimal dimensional interference between the inside portions of the mold's circumference and the perimeter portions of green tires being loaded into the mold.

Another aspect of the present invention is to provide a two-part tire mold having upper and lower portions within which the inner circumferential portions of the two portions undergo an increase in diameter when the mold is open.

Yet another aspect of the present invention is to provide a two-part tire mold having upper and lower portions within which the inner circumferential portions of the two portions decrease in diameter upon closure of the two parts of the mold upon a green tire.

And a final aspect of the present invention is to provide a two-part tire mold having upper and lower portions from which a cured tire can be easily removed.

### SUMMARY OF THE INVENTION

The present invention is a two part tire mold comprising an upper portion and a lower portion, each portion having an internal radially outermost circumferential surface corresponding to the radially outermost circumferential surface of a green tire. The upper and lower portions each has means for causing the internal radially outermost circumferential surface to expand to a first radially outermost diametrical dimension prior to the loading of the green tire as well as means for causing the internal radially outermost circumferential surface to contract to a second radially outermost diametrical dimension corresponding to the radially outermost circumferential surface of the green tire subsequent to the loading of the green tire into the tire mold. The means for causing the internal radially outermost circumferential surfaces of the upper portion and the lower portion to expand and contract includes a plurality of upper movable segments circumferentially disposed within the upper portion and movable from the first radially outermost diametrical dimension to the second radially outermost diametrical dimension, and a plurality of lower movable segments circumferentially disposed within the lower portion and movable from the first radially outermost diametrical dimension to the second radially outermost diametrical dimension. Means is also provided for causing the plurality of upper movable segments and the plurality of lower movable segments to move between the first radially outermost diametrical dimension and the second radially outermost diametrical dimension. The upper portion of the tire mold includes an upper sidewall ring and an upper actuating ring having the plurality of upper movable segments circumferentially disposed therein and movably guided thereby, and the lower portion includes a lifting plate, a lower sidewall ring, a lower actuating ring having the plurality of lower movable segments circumferentially disposed therein and movably guided thereby. The upper sidewall ring and the upper actuating ring are in fixed relationship to one another, and the plurality of upper movable segments can move axially and radially in relationship to the upper sidewall ring and the upper actuating ring. The lower actuating ring is affixed to a horizontal surface, and the lower sidewall ring and the lifting plate are also in fixed relationship to one another; the lower sidewall ring and the lifting plate can move axially in relation to the lower actuating ring, and means is provided for causing each segment of the plurality of lower movable segments to move radially in relationship to the lower sidewall ring and the lifting plate. The means for causing each lower movable segment of the plurality of lower movable segments to move radially in relationship to the lower sidewall ring and the lifting plate includes a stoplock pin that is affixed to each lower movable segment and a stoplock pin guide affixed to the lower sidewall ring and within which the stoplock pin is constrained to radial motion in relation to the sidewall ring. Each segment of the plurality of upper movable segments is guided in radial motion by the upper actuating ring when the plurality of upper movable segments moves axially in relation to the upper actuating ring, and each segment of the plurality of lower movable segments is guided in radial motion by the lower actuating ring when the plurality of lower movable segments moves axially in relation to the lower actuating ring. The plurality of circumferentially disposed upper movable segments has a maximum circumferential dimension when the plurality of segments is in a first axial relationship to the upper actuating ring, and the plurality of circumferentially disposed upper movable segments has a minimum circumferential dimension when the plurality of segments is in a second axial relationship to the upper actuating ring; likewise, the plurality of circumferentially disposed lower movable segments has a maximum circumferential dimension when the plurality of segments is in a first axial relationship to the lower actuating ring, and the plurality of circumferentially disposed lower movable segments has a minimum circumferential dimension when the plurality of segments is in a second axial relationship to the lower actuating ring. Each upper movable segment of the plurality of upper movable segments corresponds to one lower movable segment of the plurality of lower movable segments such that each upper movable segment and the one lower movable segment to which it corresponds each has a joining mating face such radially inward motion of the upper movable segment causes the lower movable segment to which it corresponds to move radially inward and radially outward motion of the lower movable segment causes the upper movable segment to which it corresponds to move radially outward. Each upper movable segment of the plurality of upper movable segments and each lower movable segment of the plurality of lower movable segments is disposed at a maximum radial position when the upper portion of the tire mold is disengaged from the lower portion of the tire mold.

The present invention is also a method for changing the internal dimensions of a two part tire mold comprising an upper portion and a lower portion, each portion having an internal circumferential region that is able to expand in diametrical dimension when the two part tire mold is open, comprising the steps of providing the upper portion with an upper sidewall ring and an upper actuating ring, disposing within the upper portion a plurality of circumferentially arranged upper movable segments, providing the lower portion with a lower sidewall ring, a lower actuating ring, and a lifting plate, and disposing within the lower portion a plurality of circumferentially arranged lower movable segments. The method includes the further steps of having the upper sidewall ring and upper actuating ring in fixed relationship to one another, allowing the plurality of circumferentially arranged upper movable segments to be guided axially and radially by the upper actuating ring, and affixing the lower actuating ring to a fixed surface. The method further includes the steps of having the lower sidewall ring and the lifting plate in fixed relationship to one another and allowing the lower sidewall ring and the lifting plate to move axially in fixed relationship to one another. Radial motion of the lower segments is achieved by providing each lower segment with a stoplock pin and by attaching a plurality of radially oriented pin tracks to the lower sidewall ring such that by affixing each stoplock pin within one of the plurality of radially oriented pin tracks, each lower segment can move radially in relation to the lower sidewall ring. Moving the lifting plate in an axial direction causes each lower segment to be guided by the lower actuating ring to move radially in relation to the lifting plate and the sidewall ring. Finally, the method of the present invention includes the steps of arranging of each upper movable segment so as to correspond to one lower movable segment of the plurality of lower movable segments and providing each upper movable segment and the one lower movable segment to which it corresponds with joining mating faces such that radial inward motion of the upper movable segment causes the radial inward motion of the lower movable segment to which it corresponds, and radial outward motion of the lower movable segment causes radial outward motion of the upper movable segment to which it corresponds.

### BRIEF DESCRIPTIONS OF THE FIGURES

The structure, operation, and advantages of the present invention will become apparent upon consideration of the description hereinbelow taken in conjunction with the accompanying FIGURES (FIGs.). The figures are intended to be illustrative, not limiting. Certain elements in some of the FIGURES may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Although the invention is generally described in the context of these preferred embodiments, it should be understood that the FIGURES are not intended to limit the spirit and scope of the invention to these particular embodiments.

Certain elements in selected ones of the FIGURES may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the FIGURES can be numbered such that similar (including identical) elements may be referred to with similar numbers in a single FIGURE. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications, e.g., a tire 109 having a static imbalance versus a different tire 109′ of the same design, but having a couple imbalance. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying FIGURES, wherein:

FIG. 1A is a orthogonal schematic top view of a tire mold;

FIG. 1B is a orthogonal schematic side view of an open tire mold;

FIG. 1C is a orthogonal schematic side view of a closed tire mold;

FIG. 2A is a orthogonal detailed cross-sectional side view of an open tire mold;

FIG. 2B is a orthogonal detailed cross-sectional side view of a closed tire mold;

FIG. 3 is a orthogonal detailed cross-sectional side view of one side of an open tire mold showing a stoplock pin arrangement;

FIG. 4A is a orthogonal schematic detail view of the stoplock pin arrangement when the mold is open;

FIG. 4B is a orthogonal schematic detail view of the stoplock pin arrangement when the mold is closed; and

FIG. 5 is a orthogonal detailed cross-sectional side view of the top part of a tire mold shown resting upon a hard surface such as a floor.

### DEFINITIONS

“Axial” refers to the direction that is parallel to the primary axis of a tire or a tire mold.

“Circumferential” refers to the circular portion of a cylindrical drum, that is, the circumference of the drum.

“Major Axis” refers to the major cylindrical axis of a circular cylinder.

“Radial” refers to the direction that is normal to the primary axis of a tire or to a tire mold.

### DETAILED DESCRIPTION OF THE PREFERRED EMBODIMENT

The present invention consists of an improved two part tire mold comprising an upper portion and a lower portion, each of which is able to expand diametrically (and circumferentially) so as to accommodate the loading of large and heavy green tires, primarily of the kind intended for industrial and off-road-vehicle (ORV) uses. Each upper and lower portion has an internal radially outermost circumferential surface corresponding to the radially outermost circumferential surface of a green tire. Each of the two portions, upper and lower, is able to expand in internal diametrical dimension prior to and during the loading and unloading of a green tire, and it can contract in diametrical dimension when the mold is closed upon the green tire.

Prior art tire molds used in the manufacture of ORV tires consist of two parts, a removable top portion and a fixed or stationary lower portion, both having fixed internal dimensions. However, the loading of massive ORV tires into typical two part prior art type molds, during the green-tire stage of production, can sometimes result in damage to the green tires because the diametrical and circumferential dimensions of the mold are close to that of each green tire being loaded. That is, the potential for interference between large and difficult-to-handle ORV green tires and the circumferential portions of the upper and lower portions of the mold can damage the green tires.

The present invention consists of a method and apparatus for providing the upper and lower portions of two-part tire molds with an expansible opening to provide clearance for the insertion of green tires, in particular large green tires of the sort used on industrial or off-road vehicles. The tire mold according to the present invention provides a segmented tire mold wherein a plurality of circumferentially arranged segments that contribute to the shaping of the circumferential tread portion of a tire being molded are able to move in such a way as to include a radial component of motion that provides a larger diameter for each of the two mold portions during the green tire loading operation. Thus the internal circumferential region of the top portion and of the bottom portion each has means for causing the internal radially outermost circumferential surface to expand to a first radially outermost diametrical dimension prior to the loading of the green tire, and each has means for causing the internal radially outermost circumferential surface to contract to a second radially outermost diametrical dimension corresponding to the radially outermost circumferential surface of the green tire subsequent to the loading of the green tire into the tire mold.

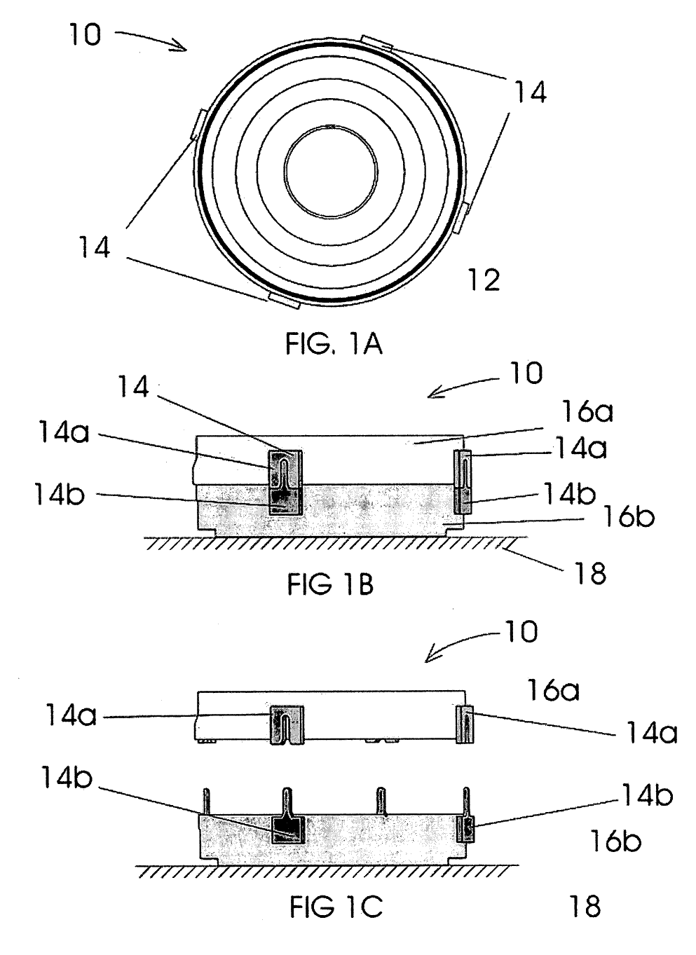

Referring to FIG. 1A, there is shown an orthogonal schematic top view of a tire mold 10 having a central hole 12 and four alignment dowels 14. FIG. 1B is an orthogonal schematic side view of the tire mold 10, comprising a top portion 16a, a bottom portion 16b, and interlocking alignment dowels 14 each consisting of an upper dowel portion 14a and a lower dowel portion 14b. The lower or bottom portion 16b of the tire mold 10 is situated upon a stationary surface 18, such as a floor or stationary mounting platform. FIG. 1C is an orthogonal schematic side view of the tire mold 10 showing the top portion 16a removed from, or lifted away from, the bottom portion 16b. Upper and lower interlocking alignment dowel portions 14a, 14b are shown disengaged from one another.

The aforementioned means for causing the internal radially outermost circumferential surface of the upper and lower portions of the tire mold to expand or contract includes a plurality of upper movable segments circumferentially disposed within the upper portion and movable from the first radially outermost diametrical dimension to the second radially outermost diametrical dimension and a plurality of lower movable segments circumferentially disposed within the lower portion and movable from the first radially outermost diametrical dimension to the second radially outermost diametrical dimension. Means is also provided for causing the plurality of upper movable segments and the plurality of lower movable segments to move between the first radially outermost diametrical dimension and the second radially outermost diametrical dimension, as will become evident upon contemplation of the description below in association with the accompanying FIGURES.

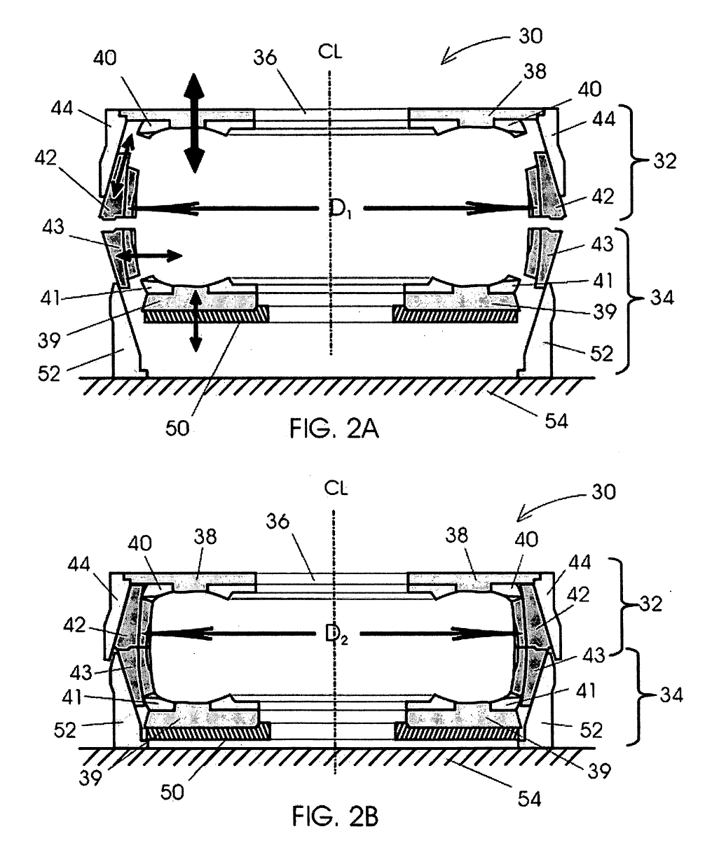

Referring now to FIGS. 2A, 2B there are shown in orthogonal cross-sectional side views two views of the tire mold 30 according to the present invention. FIG. 2A shows the mold 30 with the top or upper portion 32 separated from the lower portion 34, as would be the situation prior to the closing of the mold upon a green tire (not shown). The top portion 32 comprises a central opening 36, a sidewall ring 38, a tread ring 40, and an upper plurality of circumferentially arranged upper movable segments 42 that are slidably mounted within the top part 32 of the mold 30. The segments 42 are able to move in unison in relation to the upper conical section annular actuating ring 44, which, when the segments move upward in relation to the actuating ring, positions the segments radially inward of where they are located when they are in the downward location shown. I.e., when the segments 42 are the lowest position in relation to the actuating ring 44, the effective diameter of the top mold portion 32 corresponds to the dimension designated by D₁. Referring to FIG. 2B, wherein the upper segments 42 are shown in different position relative to the upper conical section annular actuating ring 44 in FIG. 2A, i.e., specifically with each segment making contact with the tread ring 40, the effective diameter D₂ between the segments in the top portion 32 of the mold 30 is less than D₁.

The upper movable segments 42 circumferentially disposed within the upper actuating ring 44 of the upper portion of the mold 30 can be movably guided axially and radially in relation to the upper sidewall ring 38 and the upper tread ring 40 and the upper actuating ring. Each upper movable segment 42 of the plurality of circumferentially disposed upper movable segments disposed within the upper portion is positioned radially inward or outward according to its axial location within the upper actuating ring 44.

Referring again to FIG. 2A, the lower portion 34 of the mold 30 includes a lower tread ring 41, a lower sidewall ring 39, and a lower plurality of lower movable segments 43. The lower movable segments 43 are able to move radially only in relation to the sidewall ring 39 and tread ring 41, the latter components being disposed upon a lifting plate 50 which moves the lower mold portion 34 relative to the lower conical section annular actuating ring 52 which is stationary in relation to the floor 54 or other fixed horizontal mounting surface upon with the tire mold 30 is mounted. Referring to FIG. 2B, wherein the lifting plate 50, along with the sidewall ring 39 and the tread ring 41, is shown in a lowered position relative to the lower conical section annular actuating ring 52, the lower segments 43, having moved vertically along with the lifting plate, sidewall ring, and tread ring, have also moved radially inward to locations that correspond to closed-mold radial dispositions of the upper segments 42, i.e., specifically with each segment 43 making contact with the lower tread ring 41, such that the effective diameter D₂ between the segments in the bottom or lower portion 34 of the mold 30 is less than D₁ when the mold is in the open position of FIG. 2A. Note that the upper sidewall ring 39 and the upper actuating ring 44 are in fixed relationship to one another and that the plurality of upper movable segments 42 can move axially and radially in relationship to the upper sidewall ring 44 and the upper actuating ring. Note also that the lower sidewall ring 39 and the lifting plate 50 are also in fixed relationship to one another and can move axially in relation to the lower actuating ring 52 which is affixed to a horizontal surface such as a floor.

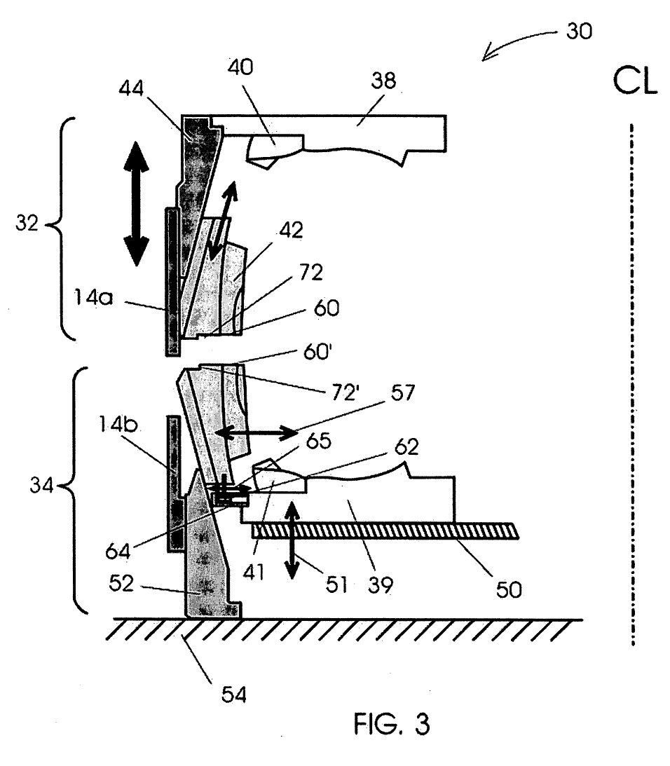

FIG. 3 is an orthogonal cross-sectional view of the left side of the upper or top part 32 and the lower or bottom part 34 of the tire mold 30, shown with the two parts in separated disposition relative to one another such that the mold is in a fully open position as would be the case if the mold were closing upon, or about to close upon, a green tire. (NOTE: The same callout numbers are used to denote elements that are substantially unchanged between the different FIGURES.) The bottom sidewall ring 39 and the tread ring 41 sit upon lifting plate 50. Bottom actuating ring 52 is situated upon a flat surface 54, which is not necessarily the floor of the tire-building facility, though it could be the floor. The lifting plate 50 moves vertically, according to the arrow 51, carrying with it the sidewall ring 39, tread ring 41, and the segments 43 (only one of which is shown). Each segment 43 slidably moves within the bottom actuating ring 52, which is a circumferential ring that engages the plurality of circumferentially disposed segments 43 such that when the lifting plate 50 moves downward (along with the sidewall ring 39 and the tread ring 41), the segments 43 move radially inward according to the arrow 57.

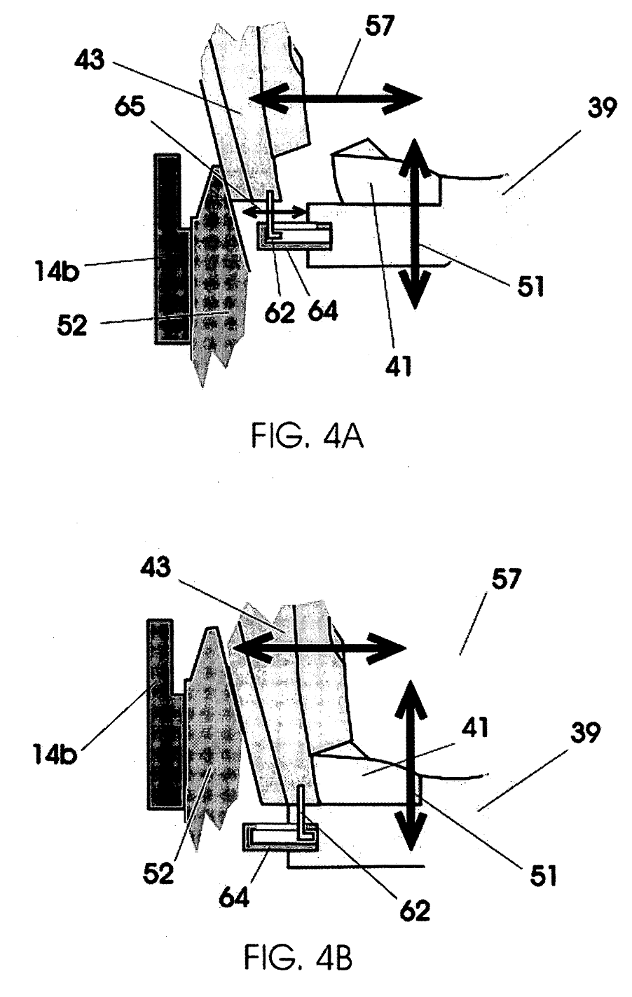

Notice in FIG. 3 the stoplock pin 62 that moves horizontally, as indicated by the two-headed arrow 65 within the stoplock pin guide 64, which is shown in more detail in FIG. 4. Note also the mating shapes of the joining mating faces 60,60′ of the respective upper and lower segments 42,43. The lower plurality of lower movable segments 43 is circumferentially disposed within the lower actuating ring 52, with each lower segment having connected thereto a stoplock pin 62 that is constrained from vertical motion in relation to the lower sidewall ring and lower tread ring and the lifting plate by the stoplock pin guide 64. In other words, each stoplock pin 62 associated with each lower segment 43 is guided by the stoplock pin track or guide 64 to move radially in relation to the lower sidewall ring 39, the lower tread ring 41 and the lifting plate 50. Thus each lower movable segment 43 of the plurality of lower movable segments in the lower portion 34 is positioned radially inward or outward according to its axial location within the lower actuating ring 52.

In summary, each upper movable segment 42 of the plurality of upper movable segments and the one lower movable segment of the plurality of lower movable segments to which it corresponds each has a mating face with a complementary catch that engage one another when the tire mold is closed upon a green tire.

The dynamics of the mold closing sequence and process is discussed in more detail below.

FIGS. 4A,4B illustrate the operation of the stoplock mechanism 62 in relation to such adjacent structures as the bottom actuating ring 52, the plurality of segments 43, and the vertical motioning sidewall ring 39 and tread ring 41. The stoplock mechanism comprises a stoplock pin 62, one of which is attached to each of the segments 43, and the stoplock pin's pin track 64 which is integral with the sidewall ring 39 or with other mold parts that move integrally with the sidewall ring. The stoplock pin 62 is constrained from moving vertically in relation to the sidewall ring 39 and related parts such as the tread ring 41 and the lifting plate (not shown in this view). The view in FIG. 4A shows the relative locations of the sidewall ring 39 and tread ring 41 and the stoplock pin guide 64, all of which move integrally in a vertical direction; also shown is a lower segment 43 with integrally attached stoplock pin 62, which constrains the segment 43 to move horizontally in relation to the sidewall ring 39 and tread ring 41 when the combination of sidewall ring, tread ring, segment, and stoplock pin and guide move vertically in relation to the stationary actuating ring 52. A lower alignment dowel 14b is also shown attached to the actuating ring 52. When the mold is closed upon a green tire, each upper alignment dowel of the plurality of upper alignment dowels and the one lower alignment dowel of the plurality of lower alignment dowels to which it corresponds each engage one another.

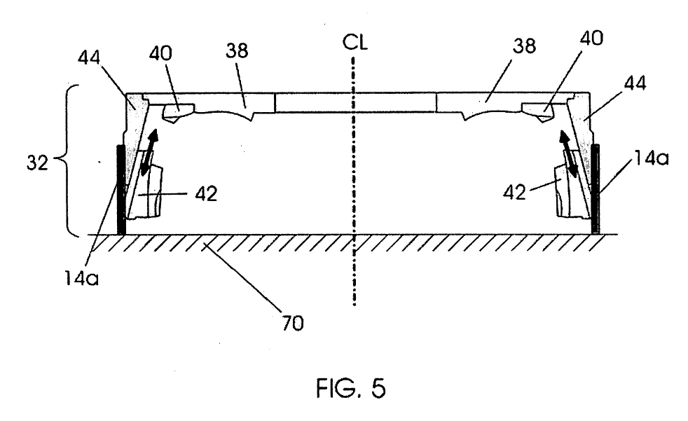

FIG. 5 is an orthogonal cross-sectional view of the top part 32 situated on a hard surface 70 such as a floor during the loading of the green tire into the lower portion of the mold (not shown). Note that the segments 42, of which there are in total several dozen that are circumferentially disposed around the perimeter of the top portion 32 are able to slide to a lowermost position as shown, and that the dowels 14a carry the weight of the mold top portion 32 while it sits upon the surface 70. Note: The present embodiment of the invention incorporates four dowels 14a and a plurality of circumferentially disposed segments 42; the segments 42 are constrained from falling out of the top portion 32 by means other than the dowels 14a, as FIG. 5 implies is the case.

The dynamics of the mold closing process, and the corresponding radially inward motions of the respective segments in the top and bottoms portions of the mold can be understood upon contemplation of the views illustrated in FIG. 3. The green tire loading sequence proceeds as follows:

With the upper portion 32 of the mold 30 removed and stored out of the way (as shown in FIG. 5), a green tire (not shown) is loaded into the mold's lower portion 34, the lifting plate portion 50 being at maximum vertical elevation relative to the lower actuating ring 52. Also at maximum vertical elevation are those parts of the lower mold portion 34 that are lifted by the lower actuating ring 52, namely the sidewall ring 39, the tread ring 41, and the segments 43, the latter being disposed at maximal radial displacement from one another so as to accomplish the intent of the present invention, which is to provide clearance for the insertion of a green tire.

Once the green tire had been loaded into the lower mold portion 34, the upper mold portion 32 is lowered onto the green tire and the lower mold portion in such a way as to ensure the engagement of the upper and lower alignment dowels, 14a and 14b respectively. Note that the mating faces 60 and 60′ of the respective upper segments 42 and the lower segments 43 are shaped so as to provide a mating and/or joining faces having catches 72 and 72′ on the respective joining mating faces 60,60′. As the upper mold portion 32 is lowered onto the lower mold portion 34 with a green tire located therebetween, catch 72 of the upper segment 42 engages the corresponding catch 72′ of the lower segment 43, such that as the weight of the upper mold segment presses downward, the upper segments 42 are forced radially inward by the upper actuating ring 44. Since the upper segments 42 engage the lower segments 43 by way of the respective catches 72,72′, the lower segments get forced radially inward upon the green tire contained in the mold 30 while the vertically movable parts of the lower mold portion 34, said movable parts including the sidewall ring 39, tread ring 41 and lifting plate 50, get pushed in a downward direction such that the lower actuating ring 52 forces the lower segments 43 radially inward against the tread portion of the green tire (not shown). When the mold 30 is fully closed and the top segments 42 and the bottom segments 43 are in their radially inward most locations (with respect to centerline CL), the upper dowels 14a engage and lock with the lower dowels 14b.

The dynamics of the mold opening process, and the corresponding radially outward movement of the respective segments in the upper and lower portions of the mold can be understood upon contemplation of the views illustrated in FIGS. 2A and 2B. The unloading sequence of the vulcanized or cured tire proceeds as follows:

The upper part 32 of the mold 30 is hoisted or otherwise lifted vertically off of the tire (not shown) and the lower portion 34 of the mold. Upon lifting of the upper portion 32, the circumferentially disposed plurality of movable segments 42 disposed therein slide or otherwise move to a lower and diametrically larger position within the conical section upper actuating ring 44, causing said segments to move radially apart from one another with respect to the main axis CL of the upper portion 32 of the tire mold 30.

Upon removal of the upper portion of the tire mold 30, the cured tire (not shown in the FIGURES) resides within the lower portion 34 of the mold 30 until an upward force is applied to the lifting plate 50 such that the lower sidewall plate 39 and tread plate 41 are elevated with respect to the stationary surface 54 such as a floor upon which the lower portion of the tire mold is mounted and with respect to the lower conical section actuating ring 52. The upward motion of the lifting plate 50, the sidewall ring 39 and the tread ring 41 also causes the plurality of movable lower segments 43 to move upward with respect to the lower conical section actuating ring 52, thereby allowing the segments to move radially apart from one another with respect to the main axis CL of the lower portion 34 of the tire mold 30. That is to say, the lifting of the lifting place 50 and the parts lifted by the lifting plate causes the tire to rise upward and the movable segments to move apart from one another and from the tire, thereby providing clearance for easy removal of the tire.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed:

1. A two part tire mold comprising an upper portion and a lower portion, the upper portion and the lower portion each having an internal radially outermost circumferential surface corresponding to the radially outermost circumferential surface of a green tire; the tire mold comprising:
the upper and lower portions each having means for causing the internal radially outermost circumferential surface to expand to a first radially outermost diametrical dimension prior to the loading of the green tire; and
means for causing the internal radially outermost circumferential surface to contract to a second radially outermost diametrical dimension corresponding to the radially outermost circumferential surface of the green tire subsequent to the loading of the green tire into the tire mold.

2. The two part tire mold of claim 1 wherein the means for causing the internal radially outermost circumferential surfaces of the upper portion and the lower portion to expand and contract includes:
a plurality of upper movable segments circumferentially disposed within the upper portion and movable from the first radially outermost diametrical dimension to the second radially outermost diametrical dimension;
a plurality of lower movable segments circumferentially disposed within the lower portion and movable from the first radially outermost diametrical dimension to the second radially outermost diametrical dimension; and
means for causing the plurality of upper movable segments and the plurality of lower movable segments to move between the first radially outermost diametrical dimension and the second radially outermost diametrical dimension.

3. The two part tire mold of claim 2 wherein:
the upper portion includes:
an upper sidewall ring; and
an upper actuating ring having the plurality of upper movable segments circumferentially disposed therein and movably guided thereby; and
the lower portion includes:
a lifting plate;
a lower sidewall ring; and
a lower actuating ring having the plurality of lower movable segments circumferentially disposed therein and movably guided thereby.

4. The two part tire mold of claim 3 wherein:
the upper sidewall ring and the upper actuating ring are in fixed relationship to one another; and
the plurality of upper movable segments can move axially and radially in relationship to the upper sidewall ring and the upper actuating ring.

5. The two part tire mold of claim 3 wherein:
the lower actuating ring is affixed to a horizontal surface;
the lower sidewall ring and the lifting plate are in fixed relationship to one another;
the lower sidewall ring and the lifting plate can move axially in relation to the lower actuating ring; and
means for causing each segment of the plurality of lower movable segments to move radially in relationship to the lower sidewall ring and the lifting plate is provided.

6. The two part tire mold of claim 5 wherein:
the means for causing each lower movable segment of the plurality of lower movable segments to move radially in relationship to the lower sidewall ring and the lifting plate includes:
a stoplock pin that is affixed to each lower movable segment; and
a stoplock pin guide that is affixed to the lower sidewall ring and within which the stoplock pin is constrained to radial motion in relation to the sidewall ring.

7. The two part tire mold of claim 3 wherein:
each segment of the plurality of upper movable segments is guided in radial motion by the upper actuating ring when the plurality of upper movable segments moves axially in relation to the upper actuating ring; and
each segment of the plurality of lower movable segments is guided in radial motion by the lower actuating ring when the plurality of lower movable segments moves axially in relation to the lower actuating ring.

8. The two part tire mold of claim 7 wherein:
the plurality of circumferentially disposed upper movable segments has a maximum circumferential dimension when the plurality of segments is in a first axial relationship to the upper actuating ring;
the plurality of circumferentially disposed upper movable segments has a minimum circumferential dimension when the plurality of segments is in a second axial relationship to the upper actuating ring;
the plurality of circumferentially disposed lower movable segments has a maximum circumferential dimension when the plurality of segments is in a first axial relationship to the lower actuating ring; and
the plurality of circumferentially disposed lower movable segments has a minimum circumferential dimension when the plurality of segments is in a second axial relationship to the lower actuating ring.

9. The two part tire mold of claim 2 wherein each upper movable segment of the plurality of upper movable segments corresponds to one lower movable segment of the plurality of lower movable segments.

10. The two part tire mold of claim 9 wherein each upper movable segment and the one lower movable segment to which it corresponds each has a joining mating face.

11. The two part tire mold of claim 10 wherein the joining mating face of each upper movable segment and the one lower movable segment which it corresponds join one another such that:
radially inward motion of the upper movable segment causes the lower movable segment to which it corresponds to move radially inward; and
radially outward motion of the lower movable segment causes the upper movable segment to which it corresponds to move radially outward.

12. The two part tire mold of claim 2 wherein:
each upper movable segment of the plurality of upper movable segments and each lower movable segment of the plurality of lower movable segments is disposed at a maximum radial position when the upper portion of the tire mold is disengaged from the lower portion of the tire mold.

13. A method for changing the internal dimensions of a two part tire mold comprising an upper portion and a lower portion, each portion having an internal circumferential region that is able to expand in diametrical dimension when the two part tire mold is open, comprising the steps of:
providing the upper portion with an upper sidewall ring and an upper actuating ring;
disposing within the upper portion a plurality of circumferentially arranged upper movable segments;
providing the lower portion with a lower sidewall ring, a lower actuating ring, and a lifting plate; and
disposing within the lower portion a plurality of circumferentially arranged lower movable segments.

14. The method of claim 13 wherein the provisions for the upper portion includes the further step of:
having the upper sidewall ring and upper actuating ring in fixed relationship to one another.

15. The method of claim 13 wherein the disposition within the upper portion of a plurality of circumferentially arranged upper movable segments includes the further step of:
allowing the plurality of circumferentially arranged upper movable segments to be guided axially and radially by the upper actuating ring.

16. The method of claim 13 wherein the provision for a lower actuating ring includes the further step of:
affixing the lower actuating ring to a fixed surface.

17. The method of claim 13 wherein the provisions for the lower portion includes the further steps of:
having the lower sidewall ring and the lifting plate in fixed relationship to one another; and
allowing the lower sidewall ring and the lifting plate to move axially in fixed relationship to one another.

18. The method of claim 13 wherein the disposition of each movable lower segment of the plurality of circumferentially arranged lower movable segments includes the further steps of:
providing each lower segment with a stoplock pin;
attaching a plurality of radially oriented pin tracks to the lower sidewall ring; and
affixing each stoplock pin within one of the plurality of radially oriented pin tracks so as to allow each lower segment to move radially in relation to the lower sidewall ring.

19. The method of claim 18 wherein the provision of a stoplock pin for each lower segment and the affixing of each stoplock pin in a radially oriented pin track includes the further step of:
moving the lifting plate in an axial direction so that each lower segment is guided by the lower actuating ring to move radially in relation to the lifting plate and the sidewall ring.

20. The method of claim 13 wherein the disposition of each movable upper and lower segment of each plurality of circumferentially arranged upper and lower movable segments includes the further steps of:
arranging each upper movable segment so as to correspond to one lower movable segment of the plurality of lower movable segments; and
providing each upper movable segment and the one lower movable segment to which it corresponds with joining mating faces such that radial inward motion of the upper movable segment causes the radial inward motion of the lower movable segment to which it corresponds and radial outward motion of the lower movable segment causes radial outward motion of the upper movable segment to which it corresponds.
